(19) United States
(12) Patent Application Publication
(10) Pub. No.: US 2007/0093941 A1
(43) Pub. Date: Apr. 26, 2007

(54) Electronically modeled actuator controller

(76) Inventors: Sarah Kathleen Lizotte, El Segundo, CA (US); Derek Harness, Torrance, CA (US); Ernest Fernandez, San Diego, CA (US)

Correspondence Address: LOUIS L. DACHS, 1794 PALISADES DRIVE, PACIFIC PALISADES, CA, 90272, US

(21) Appl. No.: 11/255,376

(22) Filed: Oct. 21, 2005

(51) Int. Cl. G05D 7/00

(52) U.S. Cl. 700/282; 703/7

(57) ABSTRACT

The invention is a system to simulate hydraulically operated devices that are moved from one position to another position by means of an actuator control unit. In detail, the system includes a first system for accepting commands from the actuator control unit and providing an analog signal representative of the command. A second system is provided converting the analog signal to a digital signal. A third system in the form of a computer is provided for processing the digital signal and generating a digital return signal in response thereto indicative that the hydraulically operated devices have moved from the one position to the other position. A fourth system is included for converting the return signal to a second analog signal. A fifth system is provides for the return of the analog single to the actuator control unit.

### GOVERNMENT INTEREST

This invention was made under United States Government Contract No.: MDA972-00-0006 issued by the Defense Advanced Research Projects Agency on Jun. 30, 2000. Therefore, the United States Government has rights to invention specified in that contract.

### BACKGROUND OF THE INVENTION

1. Field of the Invention

The invention relates to the field of remote control modules for controlling aircraft and the like and, in particular, to a remote control such that the operator can carryon other actions along with controlling the aircraft.

2. Description of Related Art

In the development of today's aircraft, the laboratory testing of vehicle management systems prior to the actual flight testing is imperative. To accomplish this, it is often necessary to develop many forms of simulation of components and systems. One of these systems is the flight control actuation system (FCAS), which consists of an actuator control units (ACUs), hydraulic control modules and control surface position actuators. The FACS is a very expensive, highly complex system, which requires a complete hydraulics laboratory with all control surface positioning components installed for thorough testing. This system is often referred to as the “Iron Bird” and is also expensive to operate and is potentially hazardous due to the presence of high pressure hydraulic lines which can leak and/or rupture. Thus it has proven cost effective to use simulation techniques during preliminary testing of components such as the ACU.

There are numerous systems for simulating similar components. For example: U.S. Pat. No. 6,319,008B1 Avionics Simulator. In this invention an operational flight program process, which is a functional equivalent of the central processing unit of an aircraft is simulated so that the flight controls can be tested. U.S. Pat. No. 4,463,605 Simulator Circuit For electro-Hydraulically Controlled Aircraft Surfaces discloses the use of an analog model, which requires hardware changes in order to alter the configuration or to modify characteristics of the closed loop system. U.S. Pat. No. 5,552,984 Diagnostic System For Complex Systems Using virtual Components. This invention replicates Line Replaceable Units (LRU) on an aircraft by comparing the real data to simulated data and then altering the simulated data to match. U.S. Pat. No. 3,002,292 Simulated Nose Wheel Steering System discloses a system for simulating the nose wheel steering system by means of analog components. None of these inventions discloses a system for simulating the flight control surfaces and their related actuators using digital techniques.

Thus, it is a primary object of the invention to provide a system for simulating the flight control surfaces of an aircraft using digital techniques.

It is another primary object of the invention to provide a system for simulating the flight control surfaces of an aircraft using digital techniques to test an ACU.

### SUMMARY OF THE INVENTION

The invention is a system to simulate hydraulically operated devices that are used to move aerodynamic control surfaces from one position to another position by means of an actuator control unit. In detail, the system includes a first system for accepting commands in the form of a Pulse Width Modulated signal (typically 8200 Hz) from the actuator control unit and providing a dc analog current signal representative of the command. A second system converts the analog signal to a digital signal to facilitate further processing in software. A third system in the form of a computer is provided for processing the digital signals and generating the required feedback in response thereto indicative that the hydraulically operated devices have moved from the one position to the other position. A fourth system is included for converting the digital feedback signals to analog. A fifth system provides for the return of the analog signal to the actuator control unit.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is simplified diagram of a flight control system for an aircraft.

FIGS. 2A and 2B are a block diagram of the system.

FIG. 3 is a block diagram of the linear variable differential transformer (LVDT) circuit for providing results from the simulation of the hydraulic system to the actuator control unit.

### DESCRIPTION OF THE PREFERRED EMBODIMENT

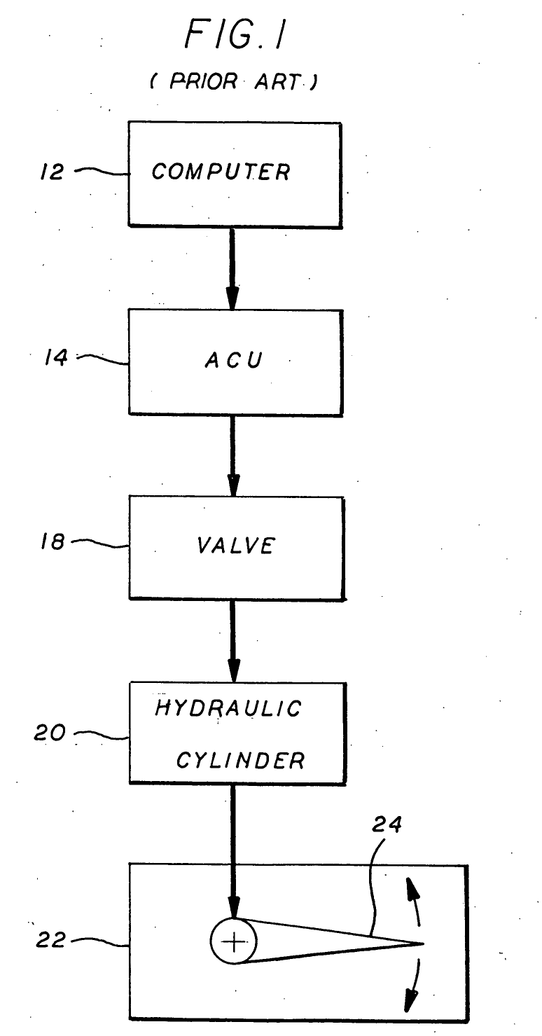

Referring to FIG. 1, a typical flight control system includes a vehicle management computer 12 for receiving pilot inputs, which provides inputs to actuator control units (ACUs) 14, which in turn actuate direct drive valves 18 (typically dc brushless permanent magnet linear motor). The valves 18 in turn control fluid flow to hydraulic cylinders 20 that are coupled to flight control surfaces 22. For example ailerons, flaps, rudders and elevators, indicated by numeral 24. There may be multiple numbers of ACUs as well as redundant hydraulic systems. The above described system is highly simplified and is provided for purposes of illustration. During testing, the full scale flight control system is assembled in a laboratory in a non-flyable structure nicknamed an “iron bird.” However, operating the iron bird is expensive, thus it has proven desirable to provide means to test components such as the ACU, without requiring actuation of the- whole iron bird.

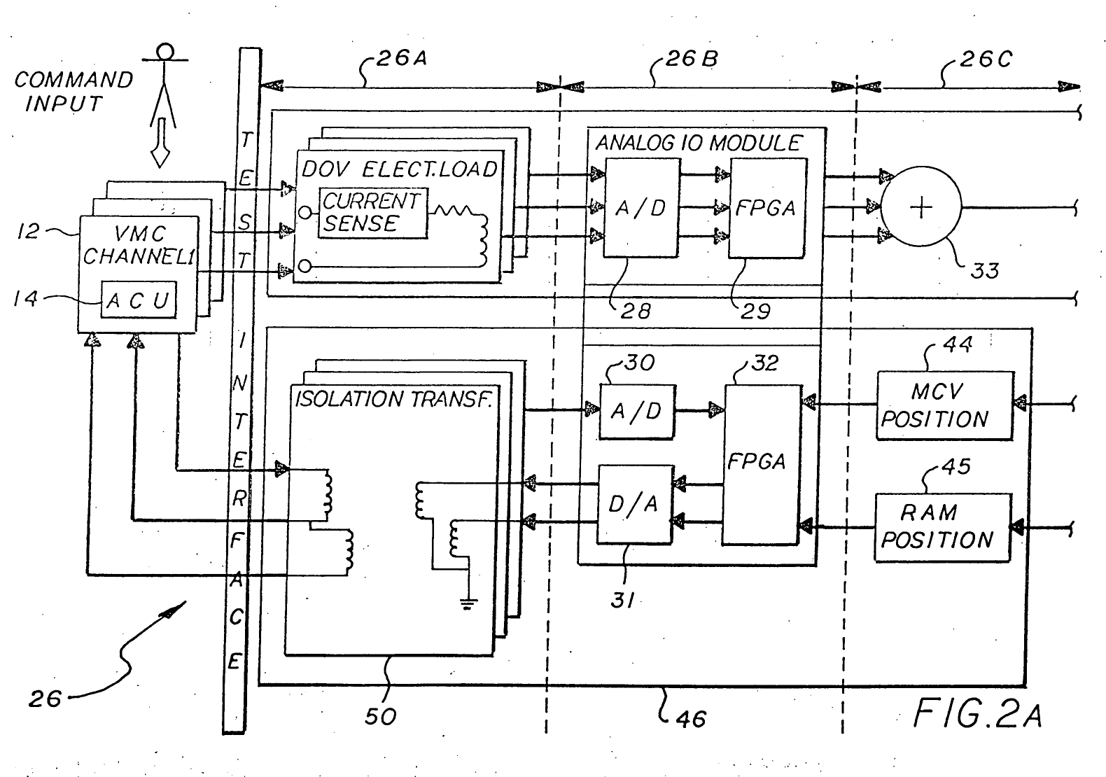

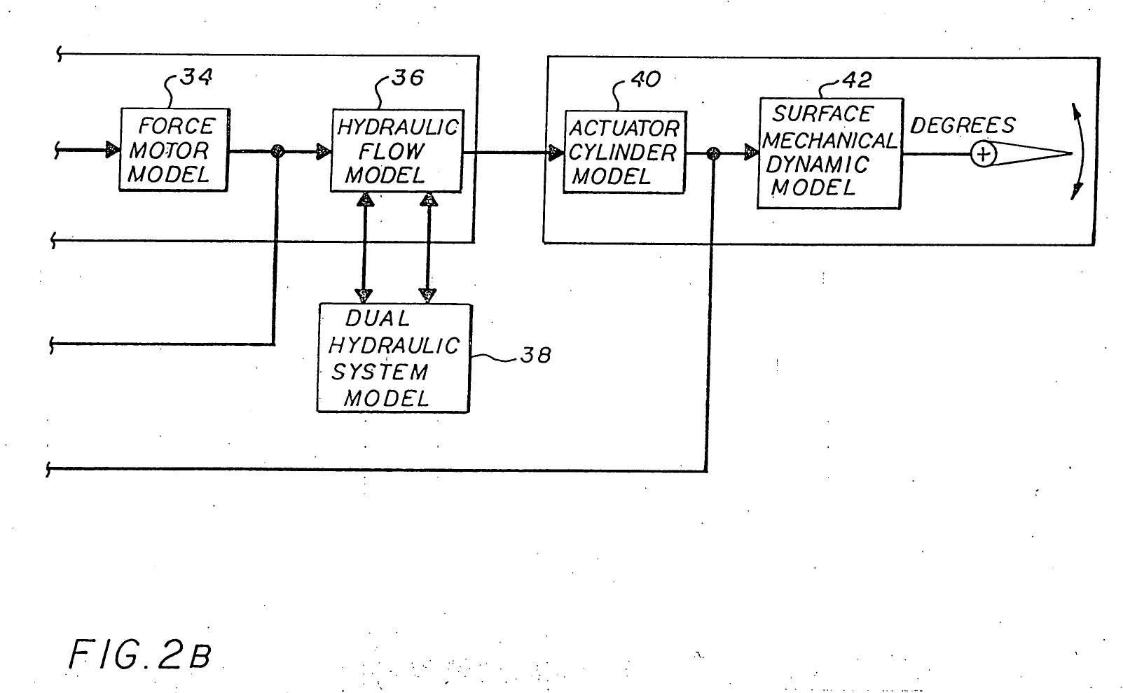

Referring to FIGS. 2A and 2B, the system 26 includes three sections: an electrical load simulation section 26A, a signal conversion section 26B and a computer simulation section 26C. The signal conversion section 26B is a commercially available analog to digital and digital to analog conversion device. For example Part Number 778668-01, manufactured by National Instruments Corporation, Austin, Tex. It includes an analog to digital converter channels 28 coupled to a field programmable gate array 29, and a digital to analog signal converter 31 coupled to another field programmable gate array 32. The function of these components will be subsequently discussed.

A vehicle management computer 12 receives flight control commands such as move rudder, ailerons, elevators, etc. and provides an output command to the ACU 14. Depending upon the aircraft, there may be one or more ACUs 14 being fed through separate channels from the vehicle management computer 12. The ACU 14 provides an output signal to an electrical load simulator 30 which simulates the direct drive valve load characteristics 18 shown in FIG. 1. The output of the load simulator 30 is fed to an analog to digital converter 28. Thereafter, the digital signals are summed (this assumes two or more ACUs 14) and passed to a force motor model program 34, to a hydraulic flow model program 36, which also receives inputs from a hydraulic system model program 38 to an actuator cylinder model program 40 and finally to an control surface model program 42.

The software programs function as follows:
1. The force motor model program 34 simulates the behavior of a linear motor used to drive the spool as part of the hydraulic control valve 18. It consists of a mathematic model that converts a current input to linear displacement. It also provides a feedback signal representing the current position of the spool to help provide for loop closure inside the ACU 12.
2. The hydraulic flow model program 36 simulates the direction and flow of fluid through the control valve 18 orifices that feed the actuator cylinder. It consists of a non-linear mathematical model that receives a position command and generates a hydraulic oil flow output. Model parameters include oil density, viscosity, leakage, pressure, specific gravity, compressibility and bulk modulus.
4. The actuator cylinder model program 40 simulates the stroke and force required to position the control surface. It consists of a mathematical model that converts hydraulic power to mechanical power to drive the piston or ram inside the cylinder 20.
5. The hydraulic system model 38 receives data from the test operator to control the state of the hydraulic systems. These states correspond to the number of systems currently active. Initial state has zero systems enable. Normal state has all systems enabled. The failed state allows the operator to fail any system or manipulate the pressure parameters in real-time as desired.
6. The control surface model 42 simulates the mechanical properties of the load including linkage to the ram. These properties include mass, stiffness (spring) and viscous friction (damping).

It should be understood that these computer programs are developed by both the manufacturer of the aircraft and the supplier of the hydraulic components. Thus they are unique to each aircraft. Typically, mathematical modeling tools such as MATLAB/Simulink (manufactured by Mathworks Corporation, Natick, Mass.) are used to create high fidelity models. These models are then used to generate code that can be used in the real-time computing system 26C.

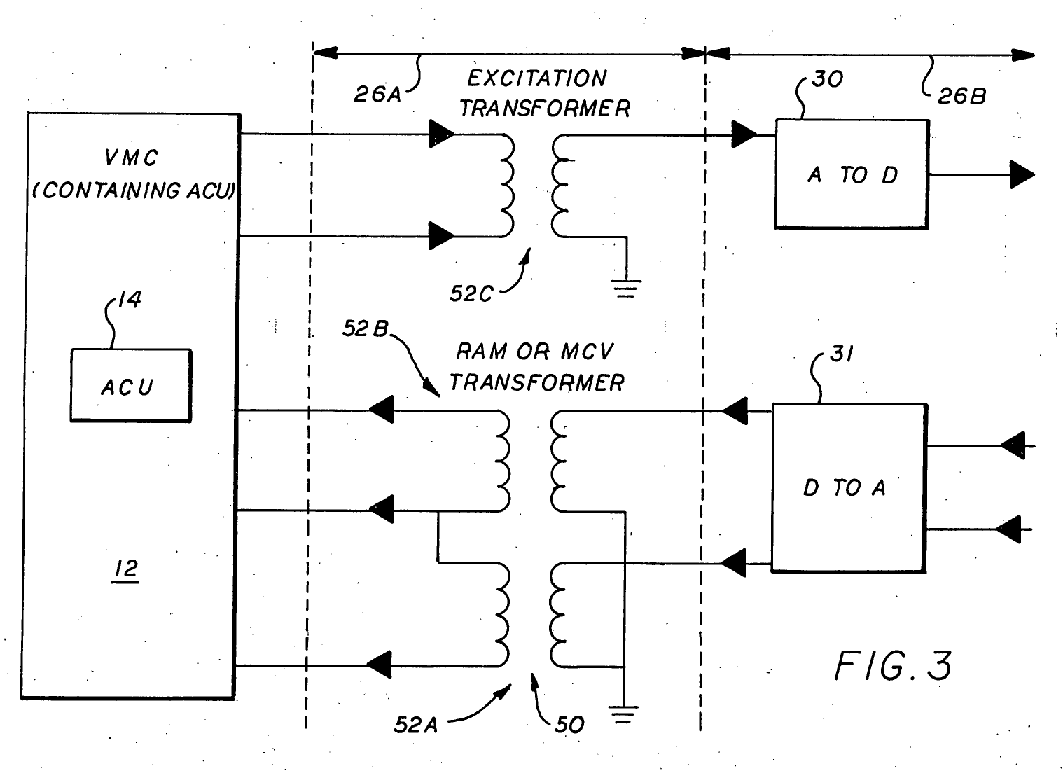

Still referring to FIGS. 2A and 2B and additionally to FIG. 3, a feedback signal 45 indicative of the actuator cylinder RAM position from the actuator cylinder model program 40 and a feedback signal 44 indicative of the spool position from the force motor model program 34 is provided to a digital LVDT feedback sensor simulation system 46 including a transformer section 50. In particular the signals pass through the second field programmable gate array 32 and on to the digital to analog converter 31 and to transformers 52A and 52B, respectively. An excitation transformer 52C receives signals from the ACU 14 provides the alternating current (AC) reference voltage that will be used by the output stage transformers later. This voltage is converted to a digital signal by analog to digital converter 30 and multiplied with the RAM position 48 or the MCV position 46, depending on what portion of what surface is moving. The resultant signal of position and digital excitation is converted back to an analog signal. The output transformers 52A and 52B are placed such that the primaries of the transformers are driven by the modulated analog signal from the Analog IO Module 52C. Because the transformers are driven differentially, the signals sent back to the ACU 14 simulate the position of the LVDT. The phase of the output signal (out of the RAM or MCV transformer 52A and 52B) with respect to the phase of the input (into the excitation transformer 52A) determines which direction the simulated LVDT is positioned with respect to center.

Thus it can be seen that by using digital techniques, a very simplified system can be used to test the ACU. Additionally, if changes are made to any of the hydraulic components comprising the FCAS system, only a software modification is required.

While the invention has been described with reference to a particular embodiment, it should be understood that the embodiment is merely illustrative as there are numerous variations and modifications which may be made by those skilled in the art. Thus, the invention is to be construed as being limited only by the spirit and scope of the appended claims.

### INDUSTRIAL APPLICABILITY

The invention has applicability to the aircraft manufacturing industry.

1. A system to simulate hydraulically operated devices that are moved from one position to another position by means of an actuator control unit, the system comprising;
first means for accepting commands from the actuator control unit and providing an analog signal representative of the command;
second means for converting the analog signal to a digital signal; and
third means for processing the digital signal and generating a digital return signal in response thereto indicative that the hydraulically operated devices have moved from the one position to the other position;
fourth means for converting the return signal to a second analog signal; and
fifth means for providing the return analog single to the actuator control unit.

2. The system as set forth in claim 1 wherein said second means is a computer.

3. The system as set forth in claim 2 wherein the hydraulically operated devices include a solenoid operated control valve to control the flow of hydraulic fluid to the devices and said first means includes means to simulate the electrical load of the direct drive valve.
